(19) United States
(12) Patent Application Publication
(10) Pub. No.: US 2014/0136204 A1
(43) Pub. Date: May 15, 2014

(54) METHODS AND SYSTEMS FOR SPEECH SYSTEMS

(71) Applicant: GM GLOBAL TECHNOLOGY OPERATIONS LLC, Detroit, MI (US)

(72) Inventors: RON M. HECHT, RAANANA (IL); OMER TSIMHONI, RAMAT HASHARON (IL); UTE WINTER, PETACH TIQWA (IL); ROBERT D. SIMS, III, MILFORD, MI (US)

(73) Assignee: GM GLOBAL TECHNOLOGY OPERATIONS LLC, Detroit, MI (US)

(21) Appl. No.: 14/059,955

(22) Filed: Oct. 22, 2013

Related U.S. Application Data
(60) Provisional application No. 61/725,804, filed on Nov. 13, 2012.

(51) Int. Cl. G10L 17/00

(52) U.S. Cl. CPC G10L 17/005
USPC 704/249

(57) ABSTRACT

Methods and systems are provided for a speech system of a vehicle. In one embodiment, the method includes: generating an utterance signature from a speech utterance received from a user of the speech system without a specific need for a user identification interaction; developing a user signature for a user based on the utterance signature; and managing a dialog with the user based on the user signature.

### CROSS REFERENCE TO RELATED APPLICATIONS

This application claims the benefit of U.S. Provisional Application No. 61/725,804 filed Nov. 13, 2012, which is hereby incorporated by reference in its entirety.

### TECHNICAL FIELD

The technical field generally relates to speech systems, and more particularly relates to methods and systems for generating user signatures for speech systems of a vehicle.

### BACKGROUND

Vehicle speech recognition systems perform speech recognition on speech uttered by occupants of the vehicle. The speech utterances typically include commands that control one or more features of the vehicle or other systems that are accessible by the vehicle such as but not limited banking and shopping. The speech dialog systems utilize generic dialog techniques such that speech utterances from any occupant of the vehicle can be processed. Each user may have different skill levels and preferences when using the speech dialog system. Thus, a generic dialog system may not be desirable for all users.

Accordingly, it is desirable to provide methods and systems for identifying and tracking users. Accordingly, it is further desirable to provide methods and systems for managing and adapting a speech dialog system based on the identifying and tracking of the users. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for a speech system of a vehicle. In one embodiment, the method includes: generating an utterance signature from a speech utterance received from a user of the speech system without a specific need for a user identification interaction; developing a user signature for a user based on the utterance signature; and managing a dialog with the user based on the user signature.

In another embodiment, a system includes a first module that generates an utterance signature from a speech utterance received from a user of the speech system without a specific need for a user identification interaction. A second module develops a user signature for the user based on the utterance signature. A third module manages a dialog with the user based on the user signature.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a speech system in accordance with various exemplary embodiments;

FIG. 2 is a dataflow diagram illustrating a signature engine of the speech system in accordance with various exemplary embodiments; and

FIG. 3 is a sequence diagram illustrating a signature generation method that may be performed by the speech system in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

In accordance with exemplary embodiments of the present disclosure a speech system 10 is shown to be included within a vehicle 12. In various exemplary embodiments, the speech system 10 provides speech recognition and/or a dialog for one or more vehicle systems through a human machine interface module (HMI) module 14. Such vehicle systems may include, for example, but are not limited to, a phone system 16, a navigation system 18, a media system 20, a telematics system 22, a network system 24, or any other vehicle system that may include a speech dependent application. As can be appreciated, one or more embodiments of the speech system 10 can be applicable to other non-vehicle systems having speech dependent applications and thus, is not limited to the present vehicle example.

The speech system 10 communicates with the multiple vehicle systems 16-24 through the HMI module 14 and a communication bus and/or other communication means 26 (e.g., wired, short range wireless, or long range wireless). The communication bus can be, for example, but is not limited to, a CAN bus.

The speech system 10 includes a speech recognition engine (ASR) module 32 and a dialog manager module 34. As can be appreciated, the ASR module 32 and the dialog manager module 34 may be implemented as separate systems and/or as a combined system as shown. The ASR module 32 receives and processes speech utterances from the HMI module 14. Some (e.g., based on a confidence threshold) recognized commands from the speech utterance are sent to the dialog manager module 34. The dialog manager module 34 manages an interaction sequence and prompts based on the command. In various embodiments, the speech system 10 may further include a text to speech engine (not shown) that receives and processes text received from the HMI module 14. The text to speech engine generates commands that are similarly for use by the dialog manager module 34.

In various exemplary embodiments, the speech system 10 further includes a signature engine module 30. The signature engine module 30 receives and processes the speech utterances from the HMI module 14. Additionally or alternatively, the signature engine module 30 receives and processes information that is generated by the processing performed by the ASR module 32 (e.g., features extracted by the speech recognition process, word boundaries identified by the speech recognition process, etc.). The signature engine module 30 identifies users of the speech system 10 and builds a user signature for each user of the speech system based on the speech utterances (and, in some cases, based on the information from the ASR module 32).

In various exemplary embodiments, the signature engine module 30 gradually builds the user signatures over time based on the speech utterances without the need by the user to actively identify oneself. The dialog manager module 34 then utilizes the user signatures to track and adjust the prompts and interaction sequences for each particular user. By utilizing the user signatures, the dialog manager module 34 and thus the speech system 10 can manage two or more dialogs with two or more users at one time.

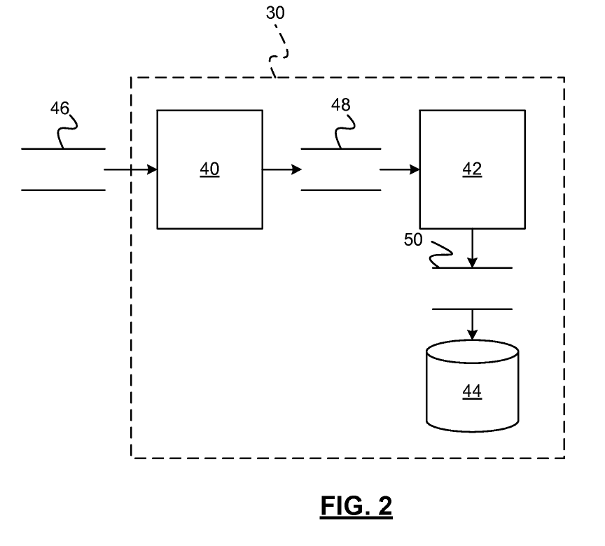

Referring now to FIG. 2, a dataflow diagram illustrates the signature engine module 30 in accordance with various exemplary embodiments. As can be appreciated, various exemplary embodiments of the signature engine module 30, according to the present disclosure, may include any number of sub-modules. In various exemplary embodiments, the sub-modules shown in FIG. 2 may be combined and/or further partitioned to similarly generate user signatures. In various exemplary embodiments, the signature engine module 30 includes a signature generator module 40, a signature builder module 42, and a signature datastore 44.

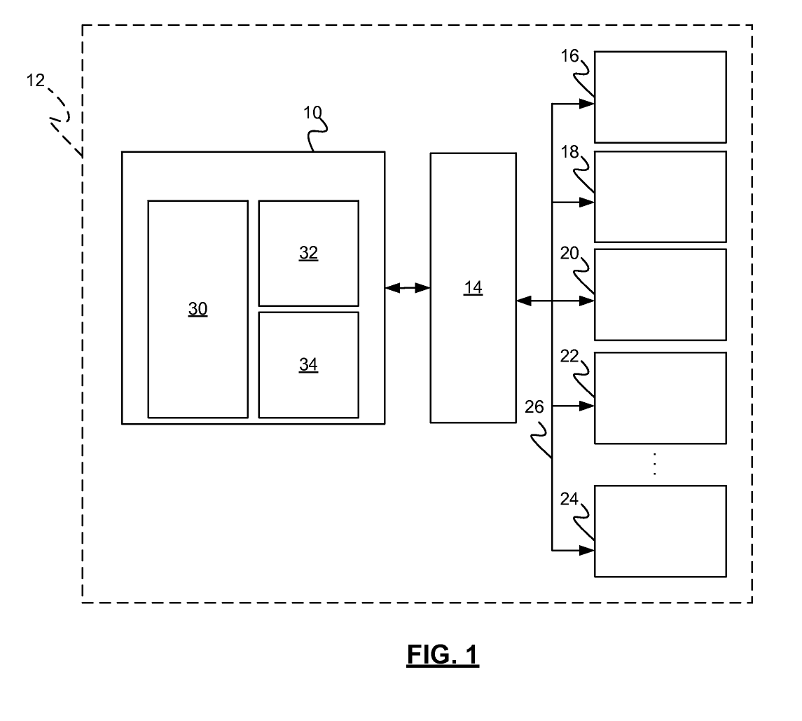

The signature generator module 40 receives as input a speech utterance 46 provided by a user through the HMI module 14 (FIG. 1). The signature generator module 40 processes the speech utterance 46 and generates an utterance signature 48 based on characteristics of the speech utterance 46. For example, the signature engine module 40 may implement a super vector approach to perform speaker recognition and to generate the utterance signature 48. This approach converts an audio stream into a single point in a high dimensional space. The shift from the original representation (i.e. the audio to the goal representation) can be conducted in several stages. For example, at first, the signal can be sliced into windows and a Mel-Cepstrum transformation takes place. This representation maps each window to a point in a space in which distance is related to phoneme differences. The faraway two points are, the less likely they are from the same phoneme. If time is ignored, this set of points, one for each window, can be generalized to a probabilistic distribution over the Mel-Cepstrum space. This distribution can almost be unique for each speaker. A common method to model the distribution is by Gaussian Mixture Model (GMM). Thus, the signature can be represented as a GMM or the super vector that is generated from all the means of the GMM's Gaussians.

As can be appreciated, this approach is merely exemplary. Other approaches for generating the user signature are contemplated to be within the scope of the present disclosure. Thus, the disclosure is not limited to the present example.

The signature builder module 42 receives as input the utterance signature 48. Based on the utterance signature 48, the signature builder module 42 updates the signature datastore 44 with a user signature 50. For example, if a user signature 50 does not exist in the signature datastore 44, the signature builder module 42 stores the utterance signature 48 as the user signature 50 in the signature datastore 44. If, however, one or more previously stored user signatures 50 exist in the signature datastore 44, the signature builder module 42 compares the utterance signature 48 with the previously stored user utterance signatures 48. If the utterance signature 48 is not similar to a user signature 50, the utterance signature 48 is stored as a new user signature 50 in the signature datastore 44. If, however, the utterance signature 48 is similar to a stored user signature 50, the similar user signature 50 is updated with the utterance signature 48 and stored in the signature datastore 44. As can be appreciated, the terms exist and do not exist refers to both hard decisions and soft decisions in which likelihoods are assigned to exist and to not exist.

For example, provided the example above, in the case that the GMM of a speaker was a MAP adapt from a universal GMM of many speakers, an alignment can be performed among the distribution parameters of the GMM of both the utterance signature 48 and the stored user signature 50. The aligned set of means can be concatenated into a single high dimensional vector. The distance in this space is related to the difference among speakers. Thus, the distance in the vectors can be evaluated to determine similar signatures. Once similar signatures are found, the GMM for each signature 48, 50 can be combined and stored as an updated user signature 50.

As can be appreciated, this approach is merely exemplary. Other approaches for generating the user signature are contemplated to within the scope of the present disclosure. Thus, the disclosure is not limited to the present example.

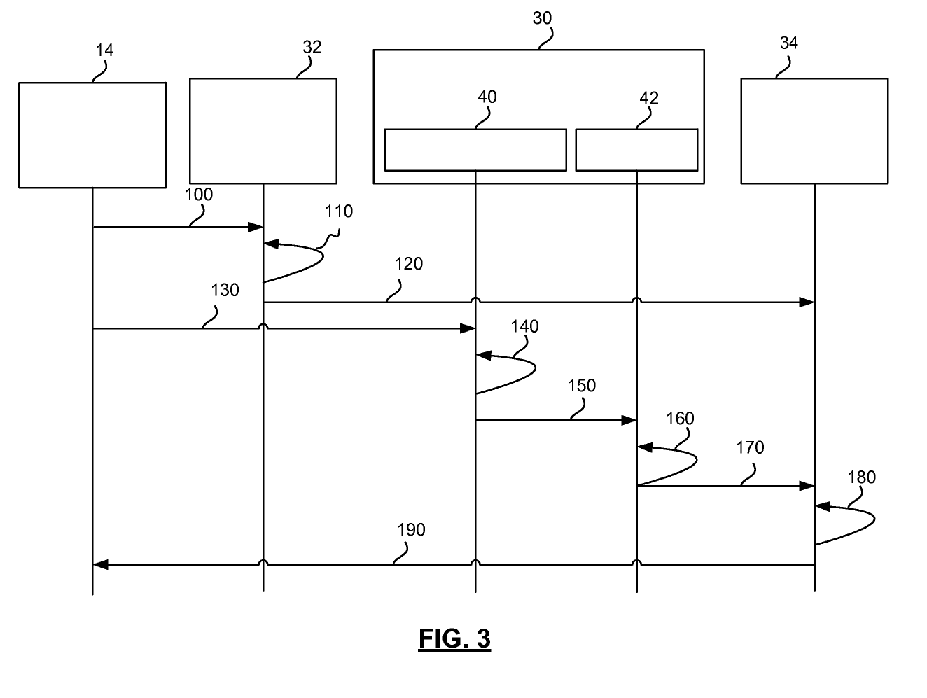

Referring now to FIG. 3, a sequence diagram illustrates a signature generation method that may be performed by the speech system 10 in accordance with various exemplary embodiments. As can be appreciated in light of the disclosure, the order of operation within the method is not limited to the sequential execution as illustrated in FIG. 3, but may be performed in one or more varying orders as applicable and in accordance with the present disclosure. As can further be appreciated, one or more steps of the method may be added or removed without altering the spirit of the method.

As shown, the speech utterance is provided by the user through the HMI module 14 to the ASR module 32 at 100. The speech utterance is evaluated by the ASR Module 32 to determine the spoken command at 110. The spoken command is provided to the dialog manager module 34 at 120 given a criterion (e.g., a confidence score). Substantially simultaneously or shortly thereafter, the speech utterance is provided by the HMI module 14 to the signature engine 30 at 130. The speech utterance is then evaluated by the signature engine 30. For example, the signature generator module 40 processes the speech utterance using the super vector approach or some other approach to determine a signature at 140. The signature builder module 42 uses the signature at 150 to build and store a user signature at 160. The user signature or a more implicit representation of the signature, such as scores, is sent to the dialog manager at 170. The dialog manager module 40 uses the user signature and the command to determine the prompts and/or the interaction sequence of the dialog at 180. The prompt or command is provided by the dialog manager module to the HMI module at 190.

As can be appreciated, the sequence can repeat for any number of speech utterances provided by the user. As can further be appreciated, the same or similar sequence can be performed for multiple speech utterances provided by multiple users at one time. In such as case, individual user signatures are developed for each user and a dialog is managed for each user based on the individual user signatures. In various embodiments, in order to improve accuracy, beam forming techniques may be used in addition to the user signatures in managing the dialog.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method for a speech system of a vehicle, comprising:
generating an utterance signature from a speech utterance received from a user of the speech system without a specific need for a user identification interaction;
developing a user signature for a user based on the utterance signature; and
managing a dialog with the user based on the user signature.

2. The method of claim 1 wherein the developing comprises developing the user signature based on the utterance signature and a stored user signature.

3. The method of claim 2 wherein the stored user signature is based on at least two previous utterance signatures.

4. The method of claim 3 wherein the stored user signature is further based on all or some of previous utterances in an interaction.

5. The method of claim 1 wherein the developing the user signature comprises determining that a user signature that is similar to the utterance signature does not exist, and storing the utterance signature as the user signature in a datastore.

6. The method of claim 1 wherein the developing the user signature comprises determining that a user signature that is similar to the utterance signature does exist, updating the user signature that is similar to the utterance signature with the utterance signature, and storing the updated user signature in a datastore.

7. The method of claim 6 wherein the determining that the user signature that is similar to the utterance signature does exist comprises determining that a user signature from a same transaction does not exist.

8. The method of claim 6 wherein the determining that the user signature that is similar to the utterance signature does exist comprises determining that a user signature from a different transaction does not exist.

9. The method of claim 1 further comprising substantially simultaneously managing a dialog with a second user based on a second user signature.

10. The method of claim 9 wherein the managing the dialog with the second user is further based on beam forming.

11. The method of claim 1 wherein the managing the dialog comprises adjusting at least one of a prompt and an interaction sequence with the user based on the user signature.

12. A speech system of a vehicle, comprising:
a first module that generates an utterance signature from a speech utterance received from a user of the speech system without a specific need for a user identification interaction;
a second module that develops a user signature for the user based on the utterance signature; and
a third module that manages a dialog with the user based on the user signature.

13. The speech system of claim 12 wherein the second module develops the user signature based on the utterance signature and a stored user signature.

14. The speech system of claim 13 wherein the stored user signature is based on at least two previous utterance signatures or based on a set of all or some previous utterances in an interaction.

15. The speech system of claim 12 wherein the second module develops the user signature by determining that a user signature that is similar to the utterance signature does not exist, and storing the utterance signature as the user signature in a datastore.

16. The speech system of claim 12 wherein the second module develops the user signature by determining that a user signature that is similar to the utterance signature does exist, updating the user signature that is similar to the utterance signature with the utterance signature, and storing the updated user signature in a datastore.

17. The speech system of claim 16 wherein the second module determines that a user signature that is similar to the utterance signature does exist by determining that a user signature from a same transaction does not exist.

18. The speech system of claim 16 wherein the second module determines that a user signature that is similar to the utterance signature does exist by determining that a user signature from a different transaction does not exist.

19. The speech system of claim 12 wherein the third module substantially simultaneously manages a dialog with a second user based on a second user signature.

20. The speech system of claim 19 wherein the third module manages the dialog with the second user based on beam forming.

21. The speech system of claim 12 wherein the third module manages the dialog by adjusting at least one of a prompt and an interaction sequence with the user based on the user signature.
